(19) United States
(12) Patent Application Publication
(10) Pub. No.: US 2005/0023804 A1
(43) Pub. Date: Feb. 3, 2005

(54) Vehicle steering wheel

(75) Inventors: Constantin Hauer, Schollkrippen (DE); Alexander Limberger, Offenbach (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/896,519

(22) Filed: Jul. 22, 2004

(30) Foreign Application Priority Data
Jul. 30, 2003 (DE) 203 11 760.3

(51) Int. Cl. B60R 25/02

(52) U.S. Cl. 280/728.3

(57) ABSTRACT

In a vehicle steering wheel, comprising a gas bag module, which has at least one first detent element, and a hub region, in which at least one second detent element is arranged, the second detent element and the first detent element undergoing a detent connection for fastening the gas bag module on the hub region. One of the detent elements has at least one unlocking section movable with respect to the at least one other detent element. The steering wheel has at least one access opening in the hub region, through which a dismantling tool is introduced in an introduction direction into the steering wheel and comes to abut against the unlocking section for a movement thereof in an unlocking direction. In a region of the access opening a support projection is provided, which is arranged with respect to the unlocking section so that with a lever movement for movement of the unlocking section in unlocking direction, the dismantling tool is supported on the support projection and tilts around it.

### FIELD OF THE INVENTION

The invention relates to a vehicle steering wheel.

### BACKGROUND D OF THE INVENTION

In order to enable a gas bag module to be quickly installed in a steering wheel, gas bag modules are frequently equipped with detent pins which can form a detent connection with spring elements on the steering wheel side, when the gas bag module is pushed in axial direction of the module, i.e. in the direction of the rotation axis of the steering wheel, into the steering wheel hub. Compared with conventional screw connections, with such a fastening also the advantage of a simple unlocking presents itself. For this, a tool, e.g. a screwdriver or a special tool, is introduced through a provided opening into the region of the detent elements and moves the spring element aside, so that the detent connection is released and the gas bag module can be removed from the steering wheel.

This unlocking is of course to take place as quickly and controlled as possible, in order to save time on the one hand and on the other hand so as to be able to prohibit the fitter from penetrating too deeply into the hub region.

### BRIEF SUMMARY OF THE INVENTION

It is an object of the invention to fulfil the above requirements.

In a vehicle steering wheel, comprising a gas bag module, which has at least one first detent element, and a hub region, in which at least one second detent element is arranged, the second detent element and the first detent element undergoing a detent connection for fastening the gas bag module on the hub region. One of the detent elements has at least one unlocking section movable with respect to the at least one other detent element. The steering wheel has at least one access opening in the hub region, through which a dismantling tool is introduced in an introduction direction into the steering wheel and comes to abut against the unlocking section for a movement thereof in an unlocking direction. In a region of the access opening a support projection is provided, which is arranged with respect to the unlocking section so that with a lever movement for movement of the unlocking section in unlocking direction, the dismantling tool is supported on the support projection and tilts around it.

Through the support projection, the unlocking path covered by the tool and the applied unlocking force can be apportioned very precisely. Compared with the conventional method, in which a displacement of the tool is transferred directly to the detent element, the unlocking force can be reduced through the use of a lever. All this leads to the unlocking process being able to be carried out “more sensitively” and exactly. In addition, through the establishing of two spatial positions, namely abutment against the unlocking section and against the support projection, an exact positioning of the dismantling tool is possible, although the unlocking section of the detent element is not visible from the exterior.

In a preferred embodiment of the invention, the second detent element has a detent section which is arranged on the side of a skeleton of the hub region facing away from the gas bag module, whereas the unlocking section is arranged on the side of the skeleton of the hub region facing the base bag module. The majority of the second detent element can therefore rest on the hub base, the second detent element only transferring small tensions to the hub. Thus, high forces can also be taken up with the triggering of the gas bag module. The unlocking of the detent element, however, can be brought about comfortably from the better accessible upper side of the steering wheel hub.

In a favourably priced embodiment, the support projection is constructed in one piece with a skeleton of the hub region.

The introduction direction can extend obliquely, in particular approximately perpendicularly to the steering wheel axis. Also, the unlocking direction can extend obliquely, in particular approximately perpendicularly to the steering wheel axis. It is advantageous for handling if both the unlocking direction and also the introduction direction lie in a plane which runs perpendicularly to the steering wheel axis, and the unlocking direction lies approximately perpendicularly to the introduction direction.

In a preferred embodiment of the invention, the second detent element is a bent spring wire, and the unlocking section stands perpendicularly to the extension plane of the remaining spring wire. In this way, the unlocking section can be grasped simply with the dismantling tool. A sideways movement of the unlocking section automatically results in a deformation of the spring wire, which represents a simple possibility for the release of the first detent elements. The first detent elements can be constructed for example as conventional detent pins.

An unlocking section can be provided at each end of the spring wire.

According to a further embodiment of the invention, a stop is provided lying in the introduction direction behind the unlocking section, constructed as a separate extension, which delimits the depth of penetration of the tool into the hub region. On inserting the dismantling tool in the introduction direction, the tip of the tool strikes onto the stop. This helps to find the correct unlocking position automatically. As soon as the tool has reached this position, the unlocking section can be effected in unlocking direction through a lever movement of the dismantling tool. In addition, the stop protects parts lying inside the steering wheel hub, such as, for example, the remaining gas bag module or electrical connections.

The stop can be L-shaped for example, one arm of the L being situated in the unlocking direction behind the deflected unlocking section. In this way, the stop can also serve as an end stop for a deflection of the unlocking section in unlocking direction. Also, in the case of an inadvertent slipping of the dismantling tool, the tip of the dismantling tool is caught by the stop.

It is possible to provide an access opening with a corresponding support projection and/or stop for each detent connection which is to be released.

A suitable rod-shaped tool, in particular a screwdriver, can be used advantageously as dismantling tool.

### BRIEF DESCRIPTION OF THE DRAWINGS

FIG. 1 shows a diagrammatic partial section of a steering wheel according to the invention, with the gas bag removed for clarity, the detent element on the steering wheel side being in detent position and with the introduced dismantling tool;

FIG. 2 shows the view of FIG. 1, the detent element on the steering wheel side being in unlocking position;

FIG. 3 shows a diagrammatic view of the hub region of the steering wheel viewed from the underside of the hub, in which the two positions of the dismantling tool are indicated; and

FIG. 4 shows a partial diagrammatic sectional view of a steering wheel according to the invention, with a gas bag module.

### DETAILED DESCRIPTION OF A PREFERRED EMBODIMENT

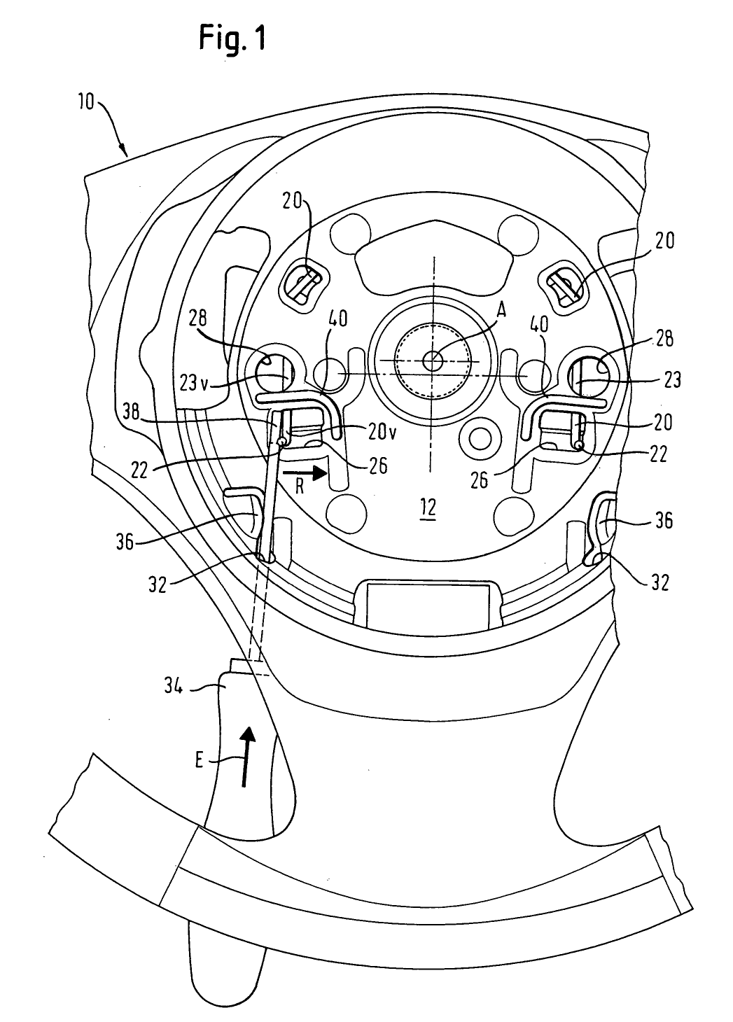

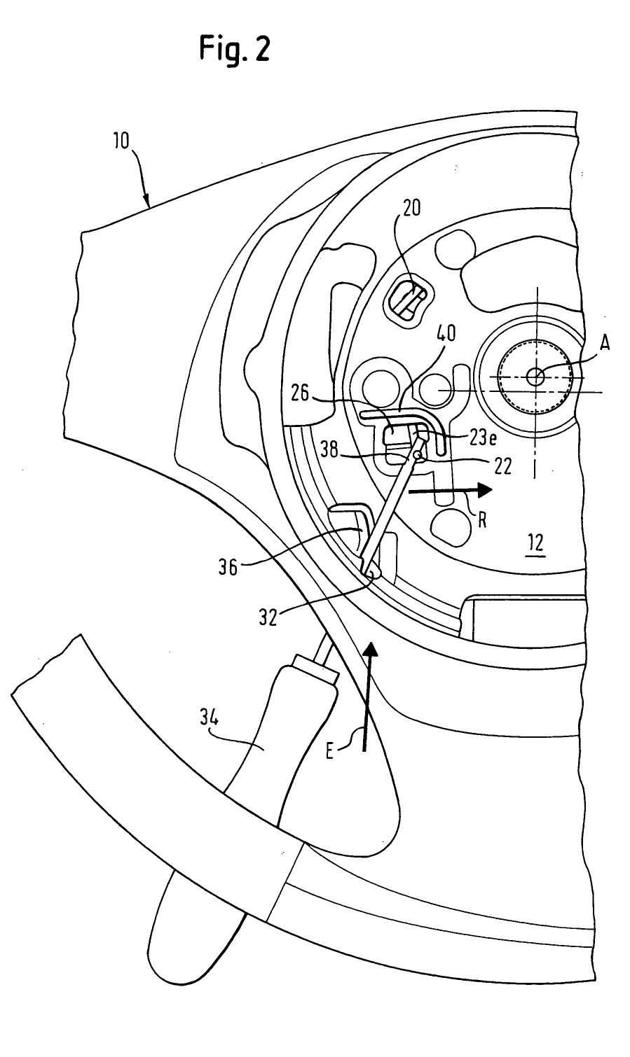

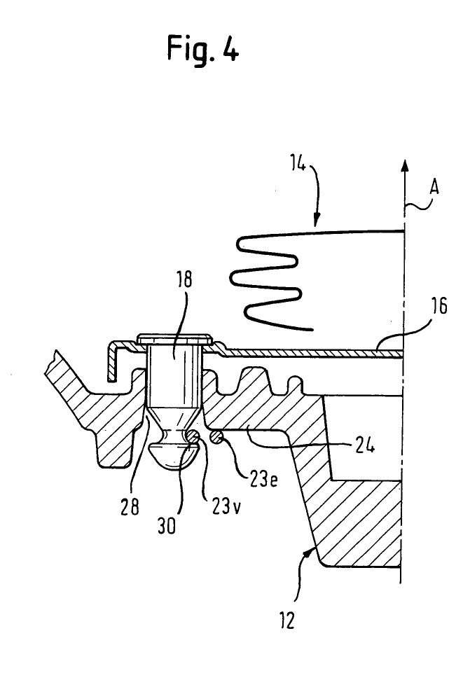

The steering wheel 10 shown in the figures has a hub region 12 (viewed from above in FIGS. 1 and 2), in which a known gas bag module 14 is held, which is shown in FIG. 4.

On a base wall 15 of a module housing of the gas bag module 14 (see FIG. 4), first detent elements 18 on the module side are fastened, in this case known detent pins which engage into a second detent element 20 on the steering wheel side, constructed as an elongated leg spring, in order to connect the gas bag module 14 with the hub region 12.

The second detent element 20 is formed into an arc, the ends of which are angled at right-angles to the plane of the arc. These angled ends serve as unlocking sections 22, whereas parts lying therebetween function as detent sections 23. The detent sections 23 are arranged entirely beneath the hub base 24. The unlocking sections 22, on the other hand, project through corresponding openings 26 in the hub base 24, so that they are accessible from the upper side of the hub base 24. The second detent element 20 is fixed to the hub region 12 by mountings not shown.

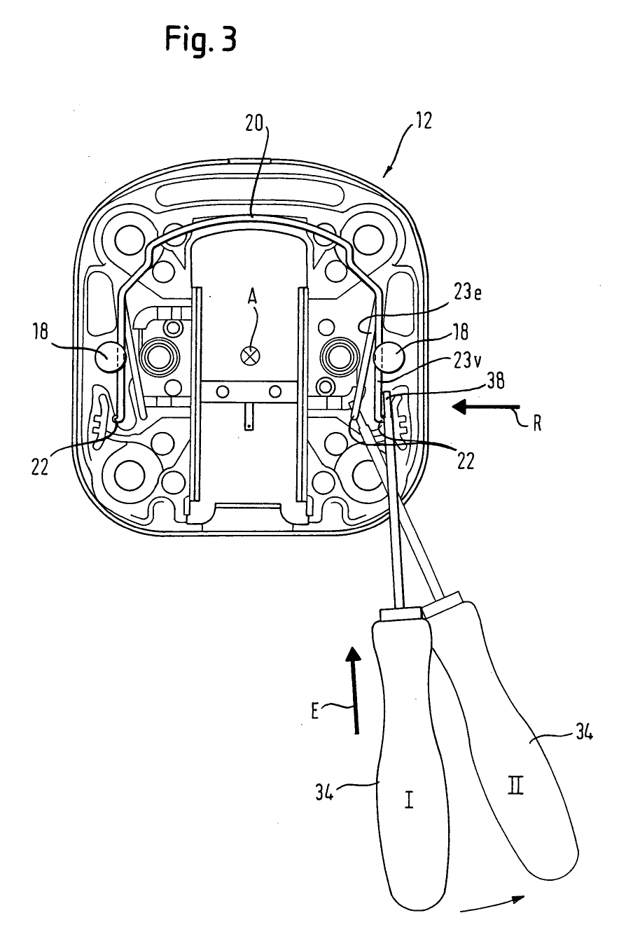

The hub base 24 has further openings 28 through which, with inserted gas bag module 14, the first detent elements 18 project (see FIG. 3). With the detent connection closed between the first and the second detent elements 18, 20, in each case a contact surface 30 on the first detent element 18 engages behind a detent section 23 of the second detent element 20 and thus fastens the gas bag module 14 in the hub region 12 of the steering wheel 10 (see FIG. 4).

The detent sections 23 can be brought from a locked position into an unlocked position, in which the gas bag module 14 can be removed from the hub region 12. In the figures, the two positions are designated by 23v for the locked position and 23e for the unlocked position.

For unlocking the detent connection 18, 20, access openings 32 for a rod-shaped dismantling tool 34 are provided in the hub region 12. The dismantling tool 34 terminates in a straight and rod-shaped section and can be a screwdriver, for example. In FIG. 3, the dismantling tool 34 is illustrated with continuous lines, for clarity, in the region of the steering wheel, although it lies on the other side of the hub region 12 and would therefore actually be hidden.

A support projection 36, constructed in one piece with a skeleton of the hub region 12, is arranged directly at the access opening 32 inside the hub region 12. If, as shown in FIG. 1, the dismantling tool 34 is pushed along an introduction direction E through the access opening 32 into the hub region 12, then a tip 38 of the dismantling tool 34 comes into abutment against the unlocking section 22 of the second detent element 20. At the same time, the dismantling tool 34 lies against the support projection 36. The support projection 36 is arranged on the side of the access opening 32 facing away from the unlocking section 22. At this moment, the detent connection is still closed between the first and second detent elements 18, 20.

The support projection 36 does not provide any holding or guiding function for the second detent element 20 and is, in fact, distanced from and not in contact with the second detent element 20 at all.

In the next step, the dismantling tool 34 is moved in a lever movement (arrow in FIG. 2), resting on the unlocking section 22 and tilting around it. Here, the tip 38 of the dismantling tool 34 and with it the unlocking section 22 moves in an unlocking direction R, perpendicularly to the introduction direction E.

Both the introduction direction E and also the unlocking direction R lie substantially perpendicularly to an axial direction A of the steering wheel 10 (which corresponds to the longitudinal direction of a steering shaft). In the example shown here, unlocking direction R and introduction direction E lie in a plane perpendicularly to the axial direction A.

Through the movement of one of the unlocking sections 22 in unlocking direction R, the corresponding detent section 23 of the second detent element 20, associated with the unlocking section 22, is moved so that the second detent element 20 frees the contact surface 30 of the first detent element 18 and releases this detent connection.

In the example shown here, two first detent elements 18 are provided, with which an access opening 32 is respectively associated. Via each access opening 32, a detent connection 18, 20 can be released. If the two detent connections are released, the gas bag module 14 can be removed from the hub region 12.

In the hub region 12, an extension is provided, constructed as an L-shaped stop 40 which, viewed in the introduction direction E, is situated behind the unlocking section 22 (see FIGS. 1 and 2). One arm of the L extends perpendicularly to the introduction direction E, whilst the second arm runs substantially parallel to the introduction opening E. This second arm, viewed perpendicularly to the unlocking direction R and in the unlocking direction R, is arranged behind the unlocking section 22. In this way, it also forms an end stop for the unlocking movement and the unlocking section 22. The stop 40 therefore delimits on the one hand the penetration depth of the dismantling tool 34 into the hub region 12 of the steering wheel 10, and on the other hand the unlocking path which the unlocking section 22 covers with the unlocking by the dismantling tool 34. In both cases, a protection of sensitive parts inside the hub region 12 from the dismantling tool 34 or the unlocking section 22 is also brought about by the stop 40.

The stop 40 here, like the support projection 36, is constructed in one piece with the skeleton of the hub region 12 or of the hub base 24.

However, it would also be possible to use parts which are separate from the skeleton for support projection 36 and stop 40. The support projection 36 and stop 40 could also be constructed in a surrounding foam or surrounding injected area of the hub base 24.

Stop 40 and support projection 36 are separate elements located at different places in the steering wheel 10.

The stop 40 could also be constructed on the base of the gas bag module 14.

The stop 40 is a separate part from the contact surface 30 constructed on the first detent element 18. Also, the second detent element 20 does not lie directly against the stop 40.

The movement of the unlocking section 22 takes place here towards the interior of the hub region 12. However, it is equally conceivable to design the system so that an unlocking is brought about in the opposite direction.

Likewise, it is possible to provide a second detent element, by which all the detent connections between the first and second detent elements can be released at the same time, in a single unlocking movement.

The arrangement of the detent elements 18, 20 could also take place in reverse, i.e. the first detent elements 18 could also be fastened on the hub region 12 and the second detent element 20 could be fastened on the gas bag module 14. Likewise, also, several second detent elements could be provided.

The first detent elements could of course also be arranged on a different component of the gas bag module, e.g. a generator carrier.

1. A vehicle steering wheel, comprising:
a gas bag module (14), which has at least one first detent element (18), and
a hub region (12), in which at least one second detent element (20) is arranged,
said second detent element (20) and said first detent element (18) undergoing a detent connection for fastening said gas bag module (14) on said hub region (12),
one of said detent elements (20) having at least one unlocking section (22) movable with respect to said at least one other detent element (18),
said steering wheel (10) having at least one access opening (32) in said hub region (12),
through which a dismantling tool (34) is introduced in an introduction direction (E) into said steering wheel (10) and comes to abut against said unlocking section (22) for a movement thereof in an unlocking direction (R),
characterized in that in a region of said access opening (32) a support projection (36) is provided,
which is arranged with respect to said unlocking section (22) so that, with a lever movement for movement of said unlocking section (22) in unlocking direction (R), said dismantling tool (34) is supported on said support projection (36) and tilts around it.

2. The vehicle steering wheel according to claim 1, wherein said support projection (36) is constructed in one piece with a skeleton of said hub region (24).

3. The vehicle steering wheel according to claim 1, wherein said introduction direction (E) extends obliquely to a steering wheel axis (A).

4. The vehicle steering wheel according to claim 1, wherein said unlocking direction (R) extends obliquely to a steering wheel axis (A).

5. The vehicle steering wheel according to claim 1, wherein said second detent element (20) is a bent spring wire and said unlocking section (22) stands perpendicular to an extension plane of the remaining spring wire (20).

6. The vehicle steering wheel according to claim 5, wherein an unlocking section (22) is provided at each end of said spring wire.

7. The vehicle steering wheel according to claim 1, wherein said second detent element (20) has at least one detent section (23), which is arranged on a side of a skeleton of said hub region (12) facing away from said gas bag module (14), whereas said unlocking section (22) is arranged on a side of said skeleton of said hub region (12) facing said gas bag module (14).

8. The vehicle steering wheel according to claim 1, wherein an access opening (32) is provided for each detent connection (18, 20).

9. The vehicle steering wheel according to claim 1, wherein said dismantling tool (34) is a rod-shaped tool.

10. A vehicle steering wheel, comprising:
a gas bag module which has at least one first detent element (18), and
a hub region (12), in which at least one second detent element (20) is arranged,
said at least one first detent element (18) undergoing a detent connection (18, 20) with said second detent element (20) for fastening said gas bag module (14) on said hub region (12),
characterized in that a stop (40), constructed as a separate projection, is provided lying in introduction direction (E) behind an unlocking section (22) of said second detent element (20), said stop (40) delimiting a penetration depth of a dismantling tool (34) into said hub region (12).

11. The vehicle steering wheel according to claim 10, wherein said stop (40) is L-shaped and an arm of said L is situated in an unlocking direction (R) behind said deflected unlocking section (22).

12. The vehicle steering wheel according claim 10, wherein said stop (40) is constructed in one piece with a skeleton of said hub region (12) or of a base wall (16) of said gas bag module (14).
